(19) United States
(12) Patent Application Publication
(10) Pub. No.: US 2017/0276214 A1
(43) Pub. Date: Sep. 28, 2017

(54) SPLIT FRAME GEARBOX

(71) Applicant: Jerry M. Cockrell, Wabasha, MN (US)

(72) Inventor: Jerry M. Cockrell, Wabasha, MN (US)

(21) Appl. No.: 15/080,629

(22) Filed: Mar. 25, 2016

(51) Int. Cl. F16H 1/20; B23B 5/16; F16H 57/021

(52) U.S. Cl. CPC F16H 1/20; F16H 57/021; B23B 5/167; B23B 2260/07; B23B 2270/025; B23B 2270/027

(57) ABSTRACT

A gearbox for mating either a hydraulic motor or a pneumatic motor to a clamshell lathe, or the like, includes a lower frame member forming a gear housing with an upper frame member as a removable cover. When the cover is removed, an input drive gear and an associated first driven gear can be readily removed and replaced to alter the gear ratio afforded by the gearbox to optimize the output torque when either the hydraulic motor or the pneumatic motor is the power source.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

I. Field of the Invention:

This invention relates generally to machine tools for performing in the field milling operations on pipes and shafts and, more particularly, to a gearbox attachable to such machine tools that is readily adaptable so as to permit use of an air motor or a hydraulic motor as a source of power.

II. Discussion of the Prior Art:

Typical of field service machining devices that are conventionally pneumatically or hydraulically driven due to the absence of electrical power at the sites where a machining operation is to be performed, for example, along a pipeline or on shafts that, because of size or installation, cannot be readily transported to a machine shop for repair, are potable machining lathes such as shown in U.S. Pat. No. 4,739,685; 4,939,964; 5,685,996 and 5,549,024. When it is considered that air motors frequently do not provide the torque that is available from hydraulic motors and that at a given work site, one may not have the option of selecting one or the other to be used to drive the field machining tool, a need exists for a gearbox that can be mounted between the output shaft of either a hydraulic motor or an air motor and the input shaft of the machining tool to adapt either an air motor or a hydraulic motor as a power source for the machining tool. As an example, the gearbox 29 of the Ricci Pat. No. 4,939,964 is designed only to mate an air motor 28 to drive ring gear 15. If at a job site a suitable air supply were not available, but only an internal combustion engine-driven hydraulic pump and hydraulic motor were available, it would be necessary to substitute a different gearbox for the gearbox 29. Such a substitute may not be readily available.

It is accordingly an object of the present invention to provide a gearbox that can readily be modified at a worksite to offer either a gear train affording higher speed and lower torque for use with a hydraulic drive or a lower speed, higher torque for use with a pneumatic drive.

### SUMMARY OF THE INVENTION

The present invention comprises a split frame gearbox for driving a metalworking tool from either a hydraulic motor or an air motor. It comprises a lower frame member of a generally rectangular box-like configuration having a bottom wall and a perpendicularly extending side wall defining a chamber with an open top. Removably affixed to upper edge of the side wall is an upper frame member. An input shaft is provided having an input gear thereon where the input shaft is journaled for rotation in a first bearing fitted into a first bore formed in an underside of the upper frame member. The input gear has a predetermined number of teeth, N₁. The input gear is made to mesh with a first driven gear that is mounted on a jackshaft journaled in second and third bearings where the second bearing resides in a second bore on the underside of the upper frame member and the third bearing residing in a first bore formed on the bottom wall. The first driven gear has a predetermined number of teeth, N₂, that is greater than N₁. A second driven gear is keyed on the same jackshaft as the first driven gear and has a number of teeth, N₃. The gearbox further includes an output shaft that is on a common axis with the input shaft and has a third driven gear keyed thereon where the third driven gear has a number of teeth, N₄ that is greater than N₃. The output shaft is journaled for rotation in a bearing disposed in a bore formed in an adaptor plate affixed to the bottom wall. By simply detaching the upper frame member, access can be had to the input gear and the first driven gear so that they can be replaced by gears offering a different gear ratio. With the upper frame member again screwed in place, the gear ratio of the split frame gearbox can be adapted to accommodate one or the other of an air motor or a hydraulic motor drive.

### DESCRIPTION OF THE DRAWINGS

The foregoing features, objects and advantages of the invention will become apparent to those skilled in the art from the following detailed description of a preferred embodiment, especially when considered in conjunction with the accompanying drawings in which like numerals in the several views refer to corresponding parts.

FIG. 1 is a perspective view viewed from the upper left;

FIG. 2 is an isometric view of the split frame gearbox when observed from the lower right; and

FIG. 3 is a cross-sectional view taken along the line 3-3 in FIG. 1.

### DESCRIPTION OF THE PREFERRED EMBODIMENT

This description of the preferred embodiment is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom”, “under”, as well as derivatives thereof (e.g., “horizontally”, “downwardly”, “upwardly”, “underside”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “joined”, and “joining” are used interchangeably and refer to one structure or surface being secured to another structure or surface or integrally fabricated in one piece unless expressly described otherwise.

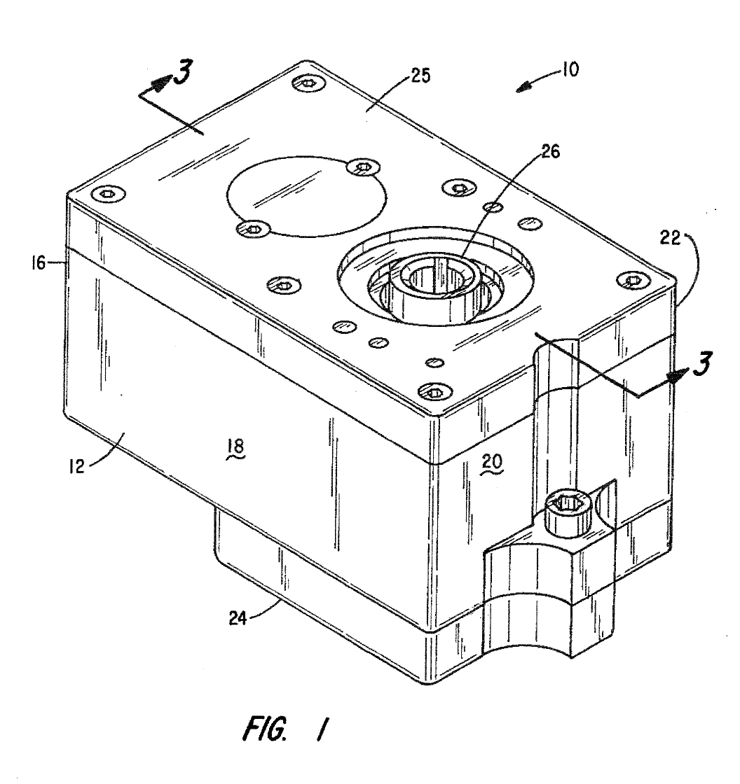

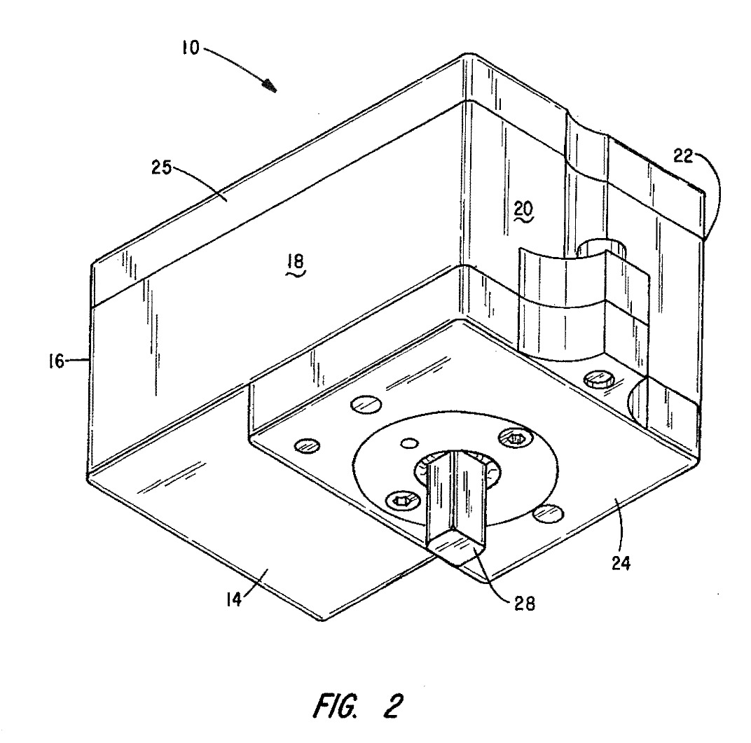

Referring to FIGS. 1 and 2, the split frame gearbox is indicated generally by numeral 10 and is seen to include a lower frame member 12 of a generally rectangular, box-like configuration having a bottom wall 14 and four mutually perpendicular side walls 16, 18, 20, 22. While the gearbox has a shape of a rectangular parallelepiped, the lower and upper frame members could just as well be circular. Bolted to the under surface of the bottom wall 14 is an adaptor plate 24 that is especially configured to allow attachment to a metalworking tool of the type described in the Background of the Invention section of the specification.

Visible in the perspective view of FIG. 1 is an input shaft 26 having a socket for receiving an output shaft from one or the other of an air motor or a hydraulic motor (not shown).

Visible in the isometric view of FIG. 2 is a square output shaft 28 that is designed to mate with a drive gear on the metalworking tool.

Bolted to the upper edges of the side walls 16-22 of the lower frame member 12 is an upper frame member 25.

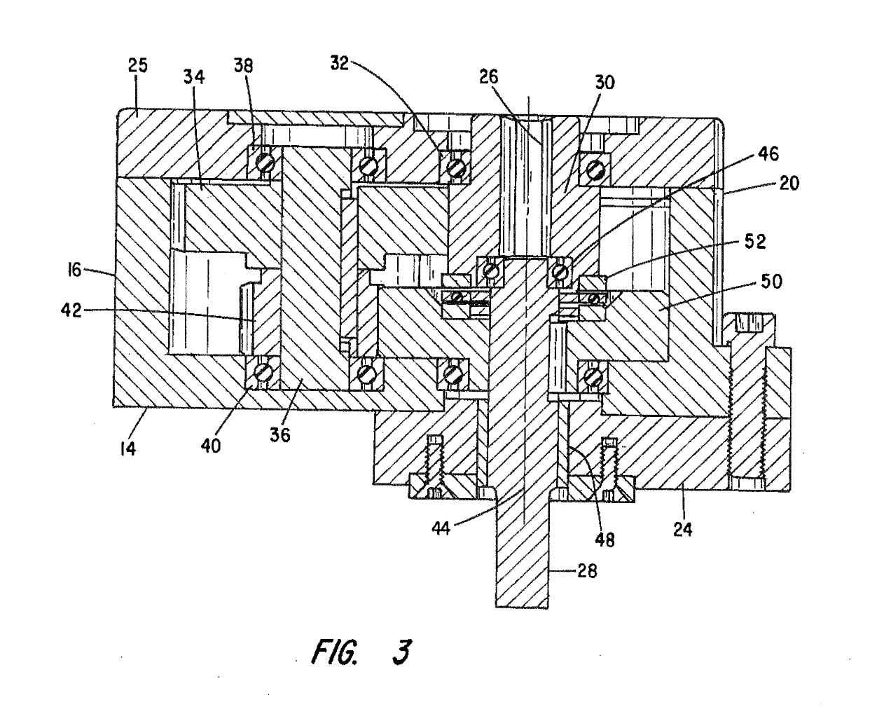

Referring next to the cross-sectional view of FIG. 3, secured to the input shaft 26 is an input spur gear 30 that is journaled for rotation by a ball bearing race 32 fitted into a bore formed in the undersurface of the upper frame member 25.

The spur gear 30 is designed to mesh with a first driven gear 34 that is keyed to a jackshaft 36 where the jackshaft 36 is journaled for rotation in a first bearing race 38 fitted into a bore formed in the undersurface of the upper frame member 25 and a bearing race 40 disposed in a bore formed in the bottom wall 14.

The jackshaft 36 also has a second driven gear 42 keyed to it.

The output shaft 28 resides on a common axis 44 with the input shaft 26 and it is journaled for rotation by a bearing race 46 at its upper end and a sleeve bearing 48 that is fitted into a bore formed through the adaptor plate 24. As seen in FIG. 3, keyed to the output shaft 28 is a third driven gear 50 that meshes with the second driven gear 42. A pilot bearing 52 is captured between input gear 30 and output gear 50 and surrounds the output shaft 28 at its upper end to thereby stabilize the output shaft.

Assuming that the input drive gear 30 has 24 teeth and the upper driven gear 34 has 48 teeth and, similarly, lower gear 42 on the jackshaft 36 has 24 teeth and the gear 50 on the output shaft has 48 teeth, the gearbox 10 provides a 4 to 1 gear ratio which provides an optimal torque if an air motor is being used as the prime mover. One can easily convert the gearbox 10 to offer a 2 to 1 ratio if hydraulic power is to be used. To do so, one need only unscrew and remove the upper frame member 25 to gain access to the gears 30 and 34. By removing them and replacing them with gears each having 36 teeth, a desirable 2 to 1 ratio is achieved when a hydraulic motor is to be used as the prime mover. This modification can be made in a matter of a few minutes.

Those skilled in the art will appreciate that using a 4 to 1 ratio allows an air motor to climb higher into the RPM range due to the load being reduced. This, of course, provides an increase in torque. By converting to a 2 to 1 ratio, the gearbox 10 closely matches the torque requirements required when utilizing hydraulic power.

It can be seen, then, that the gearbox of the present invention allows one to obtain the optimum range of speed and torque when using either an air motor or a hydraulic motor as the prime mover. It is only a simple matter to remove the upper frame member 25 and substitute gears of appropriate number of teeth for input gear 30 and the first driven gear 34.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices. Also, various modifications, both as to the equipment and operating procedures, can be accomplished without departing from the scope of the invention itself.

What is claimed is:

1. A split frame gearbox for driving a metalworking tool from one of a hydraulic motor and an air motor comprising:
a. a lower frame member of a generally box-like configuration having a bottom wall and a mutually perpendicular side wall and defining an open top;
b. an upper frame member removably affixed to an upper edge of the side wall;
c. an input gear on an input shaft, the input shaft being journaled for rotation in a first bearing fitted into a first bore formed in an underside of the upper frame member, the input gear having a number of teeth, N₁;
d. a first driven gear meshed with the input gear and mounted on a jack shaft journaled in second and third bearings, the second bearing residing in a second bore on the underside of the upper frame member and the third bearing residing in a first bore formed on the bottom wall, the first driven gear having a number of teeth N₂>N₁;
e. a second driven gear keyed on said jackshaft and having a number of teeth, N₃;
f an output shaft on a common axis with the input shaft and having a third driven gear keyed thereon, said third driven gear having a number of teeth, N₄>N₃, said output shaft being journaled for rotation in a bearing disposed in a bore formed an adapter plate affixed to the bottom wall.

2. The split frame gearbox of claim 1 and further including a pilot bearing disposed between the drive gear and the third driven gear for stabilizing the output shaft.

3. The split frame gearbox of claim 1 wherein the ratio of N₂ to N₁ is 2 to 1 and the ratio of N₄ to N₃ is 2 to 1.

4. The split frame gearbox of claim 1 wherein the ratio of N₂ to N₁ is 1 to 1 and the ratio of N₄ to N₃ is 2 to 1.

5. The split frame gearbox of claim 1 wherein the adapter plate is configured so as to be attachable to a metalworking tool to be driven from said output shaft.
